(19) United States
(12) Patent Application Publication
(10) Pub. No.: US 2005/0095176 A1
(43) Pub. Date: May 5, 2005

(54) Method and apparatus for reducing reactor fines

(76) Inventor: John D. Hottovy, Bartlesville, OK (US)

Correspondence Address: Michael G. Fletcher;Fletcher Yoder, P.O. Box 692289, Houston, TX, 77269-2289, US

(21) Appl. No.: 10/699,151

(22) Filed: Oct. 31, 2003

(51) Int. Cl. B32B 27/12; C08F 2/00

(52) U.S. Cl. 422/131; 526/64

(57) ABSTRACT

A polymerization process and apparatus in which olefin monomer is polymerized in a liquid diluent in a loop reactor having a relatively smooth inner wall. Another aspect of the invention includes a first polymerization step in which at least one olefin monomer is polymerized in a liquid diluent in a loop reactor to produce a first product fluid slurry comprising liquid diluent and solid olefin polymer particles having a relatively low melt index. A second polymerization step is then provided in which at least one olefin monomer is polymerized in a liquid diluent in the same loop reactor to produce a fluid slurry comprising liquid diluent and solid olefin polymer particles having a relatively high melt index.

### BACKGROUND OF THE INVENTION

This invention relates to the polymerization of olefin monomers in a liquid diluent.

In a typical slurry loop polymerization system, monomer (and possibly co-monomer, liquid diluent, and catalyst are fed into a continuously stirred loop reactor. The monomer (and possibly co-monomer) reacts at the catalyst in the liquid diluent to produce a product slurry containing solid olefin polymers and liquid diluent. The product slurry, which circulates in the loop reactor, is removed from the reactor and typically sent through a downstream processing system that separates the diluent from the polymer solids.

One problem associated with slurry loop polymerization systems is polymer fines created in the loop reactor. The produced polymer is in the form of particles of varying sizes suspended in the diluent. The smaller particles are referred to as fines. Fines are undesirable because they interfere with downstream equipment and polymer finishing.

There is a need for a process and apparatus for a slurry loop polymerization system that reduces the amount of fines produced in the reactor. Such a system would increase operational efficiency, lower costs, and improve the quality of product obtainable from a slurry loop polymerization reactor.

### SUMMARY OF THE INVENTION

According to the present invention, a polymerization process is provided in which olefin monomer is polymerized in a loop reactor to produce a fluid slurry comprising solid olefin polymer particles in a liquid medium. The loop reactor is defined by pipe segments having an inner wall (or inner surface) with a low friction factor. The smoother reactor wall limits the amount of polymer fines produced in the reactor.

Another aspect of the invention includes a slurry loop polymerization reactor comprising pipe segments having an inner surface with a low friction factor.

In another aspect of the invention, a first polymerization step is provided in which at least one olefin monomer is polymerized in a loop reactor to produce a first product fluid slurry comprising a liquid medium and solid olefin polymer particles having a relatively low melt index. A second polymerization step is provided in which at least one olefin monomer is polymerized in the same loop reactor to produce a second product fluid slurry comprising a liquid medium and solid olefin polymer particles having a relatively high melt index.

Objects and advantages of the invention will be apparent from the foregoing brief description of the invention and the appended claims as well as the detailed description of the invention and the drawings.

### BRIEF DESCRIPTION OF THE DRAWINGS

FIG. 1 shows a schematic perspective view of a polymerization reaction system that may be used in an aspect of this invention.

### DETAILED DESCRIPTION OF THE INVENTION

The present invention is applicable to particle form polymerizations, also referred to as slurry polymerizations, which may be conducted in a loop reactor. In this technique, feed materials such as diluent, monomer and catalyst are introduced to the loop reactor to create a slurry containing solid polyolefin particles, diluent, and unreacted monomer, and a portion of the resulting slurry is taken off or withdrawn from the reactor.

Suitable olefin monomers may be 1-olefins having up to 8 carbon atoms per molecule. The present method may be suitable for the copolymerization of ethylene and a higher 1-olefin co-monomer such as butene, 1-pentene, 1-hexene, 1-octene or 1-decene.

The present invention is applicable to any slurry polymerization in a liquid medium. The invention is particularly applicable to olefin polymerizations in a liquid diluent in which the resulting polymer is mostly insoluble under polymerization conditions. Most particularly the invention is applicable to any olefin polymerization in a loop reactor utilizing a diluent so as to produce a slurry of polymer solids and liquid diluent.

Suitable diluents (as opposed to solvents or monomers) are well known in the art and include hydrocarbons that are inert and liquid under reaction conditions. Suitable hydrocarbons include, but are not limited to, isobutane, propane, n-pentane, i-pentane, neopentane and n-hexane.

Additionally, the present techniques may be employed where the unreacted monomer is the liquid medium for the polymerization. For example, the present techniques may be used for the polymerization of propylene where propylene is the liquid medium and an inert diluent is not present in any substantial amount. A diluent may still be used for the catalyst. For illustration, but not as a limitation, the present invention will be described in connection with a polyethylene process using an inert diluent as the liquid medium, but it is to be understood that the present invention may also be employed where the monomer is used as the liquid medium and would take the place of the diluent in the following descriptions.

Polymerization catalysts are well known in the art. One suitable catalyst is chromium oxide on a support such as silica as broadly disclosed, for instance, in Hogan and Banks, U.S. Pat. No. 2,825,721 (March 1958), the disclosure of which is hereby incorporated by reference. Other catalysts which may be used include, but are not limited to, Ziegler catalysts, metallocenes, and other well-known polyolefm catalysts, as well as co-catalysts.

In commercial loop reactors, the various feed materials may be introduced to the loop reactor in various ways. For example, the monomer and catalyst may be mixed with varying amounts of diluent prior to introduction to the reactor. In the loop reactor, the monomer and catalyst may become dispersed in the fluid slurry, which circulates in the reactor. As the monomers and catalyst circulate through the loop reactor in the fluid slurry, the monomer reacts at the catalyst site in a polymerization reaction. The polymerization reaction yields solid polyolefin particles in the fluid slurry.

While several factors may influence the production of fines (which are typically considered to be polymer particles that are less than 150 micron and pass through a 100 mesh screen), it has been discovered that the amount of polymer fluff fines in a loop reaction system correlates with the calculated reactor friction factor. When polymer particles impact the wall of the reactor, sometimes they break into smaller particles. The rougher the reactor wall (as indicated by higher friction factor), the more fines produced. Using loop reactors with smoother walls, therefore, will reduce the number of fines produced in a slurry loop polymerization system.

In addition, it has been discovered that the polymer fluff fines amount in a slurry loop reactor correlates with the time that the reactor has been on line since the reactor was last opened for maintenance. Over time, in a loop polymerization reactor, rough spots on the reactor wall may be coated with polymer, or smoothed out by continuing impact by polymer particles. This lowers the overall friction factor of the reactor wall and reduces the amount of fines being produced in the reactor. During reactor maintenance, the walls of the reactor may be blasted with high pressure water (hydroblasted) to remove polymer that has built up on the reactor walls, which may lead to a higher overall reactor wall friction factor. Further, opening the reactor for maintenance may cause rust to form on the inner surface of the reactor, which may lead to a higher overall reactor wall friction factor.

One method for reducing the amount of fines produced by a reactor having a high friction factor is to provide a first polymerization step that produces polymer particles having a low melt index. The melt index of a polymer is a measurement of the polymer's viscosity, and is typically expressed in units of gm extruded from an MI machine in 10 minutes time. The polymer melt index, which is a standard form of measurement well known in the polymer production industry, is inversely proportional to the viscosity and the molecular weight of the polymer.

Polymers having a lower melt index (and therefore a higher molecular weight) are generally tougher and less likely to be broken by an impact with the reactor wall than polymers with a higher melt index. Over time, the reactor wall surface roughness may be smoothed by the polymer having a lower melt index or rough spots may be coated with polymer to lessen their effect on friction factor. After the friction factor of the reactor wall is lowered by the first polymerization step, a second polymerization step is provided that produces polymer particles having a higher melt index. The length of time of the first polymerization may depend on the size of the reactor, the melt index of the polymer produced, the velocity at which the reactor contents are circulated in the reactor, the roughness of the reactor at the start of polymerization and molecular weight of the less tough material to be produced.

Numerous methods are well known in the art for controlling the melt index of the polymer produced. For example, for chromium on silica support catalyst, increasing reactor temperature, lowering ethylene concentration, shortening residence time, lowering catalyst productivity and adding hydrogen to the reactor generally increase the melt index of the polymer. Also, changing components or treatment of the catalyst can change melt index of the polymer.

In one aspect of the present invention, a first polymerization step is provided in which at least one olefin monomer is polymerized in a liquid diluent in a loop reactor to produce a first product fluid slurry comprising liquid diluent and solid olefin polymer particles having a melt index less than 0.3 gm/10 min. Alternatively, the polymer produced in the first polymerization step may have a melt index less than 0.25, alternatively less than 0.20, alternatively less than 0.15, alternatively less than 0.10, alternatively less than 0.05.

In this aspect of the invention, a second polymerization step is then provided in which at least one olefin monomer is polymerized in a liquid diluent in a loop reactor to produce a first product fluid slurry comprising liquid diluent and solid olefin polymer particles having a melt index greater than 0.3 gm/10 min. Alternatively, the polymer produced in the second polymerization step may have a melt index greater than 0.4, alternatively greater than 0.5, alternatively greater than 0.6, alternatively greater than 0.7, alternatively greater than 0.8, alternatively greater than 1.0. The melt index of the polymer produced in the second polymerization step may be as high as 200 gm/10 min.

The slurry loop reactor used according to the present invention may be any loop reactor known in the art to be used for slurry polymerizations. An example of such a loop reactor is described in U.S. Pat. No. 5,565,175, which is incorporated by reference herein.

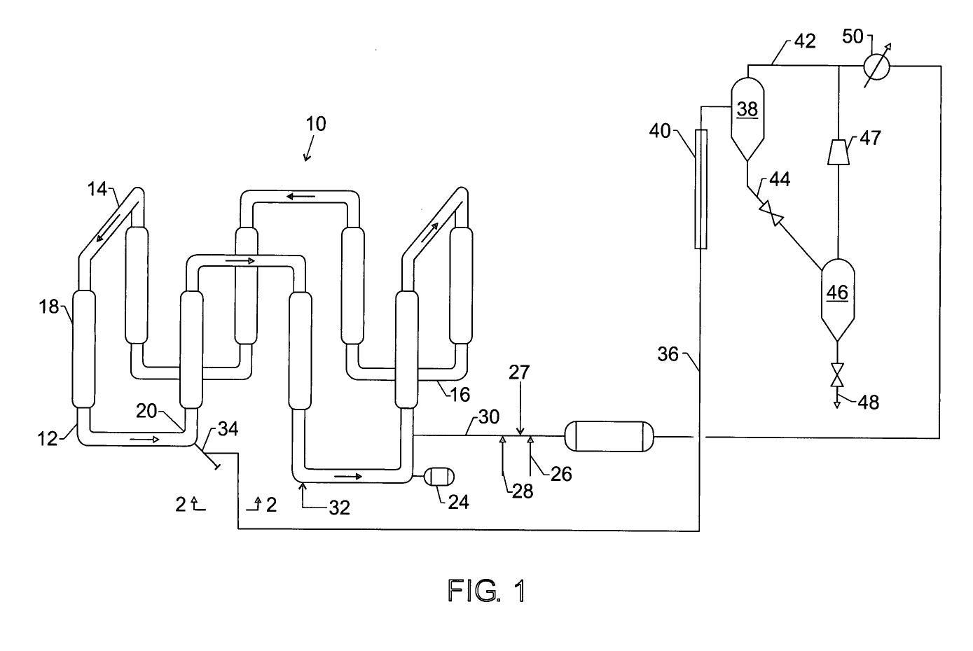

Referring now to the drawings, there is shown in FIG. 1 a loop reactor 10 having vertical segments 12, upper horizontal segments 14 and lower horizontal segments 16. These upper and lower horizontal segments define upper and lower zones of horizontal flow. Each segment or leg is connected to the next segment or leg by a smooth bend or elbow 20 thus providing a continuous flow path substantially free from internal obstructions. Alternately, no horizontal segments may be present and only the smooth bends 20 would connect the vertical sections. Also alternately, no vertical segments may be present and the smooth bends 20 would connect horizontal sections.

In this aspect of the invention, the loop reactor has eight vertical segments, although it is contemplated that the present process may be used with a loop reactor having a higher or lower number of vertical segments. The reactor is cooled by means of two pipe heat exchangers formed by a pipe and jacket. The vertical 12 and horizontal segments 14 and 16 may be formed from pipe that is constructed of rolled plate or other suitable pipe. The segments that form the loop reactor have an inner surface and an outer surface. The inner surfaces of the loop reactor segments form the inner surface of the loop reactor, which defines the reaction zone and comes into contact with the reactor contents.

The roughness of the inner surface of the loop reactor may be estimated by the friction factor and a chart such as FIG. 5-26 of the “Chemical Engineering Handbook”, Perry & Chilton, 5^{th} ed. Friction factor, which is a measurement of coefficient of pressure drop due to friction for flow in a pipe and is a function of Reynolds number and pipe relative roughness, may be calculated by solving equation 5-52 in the Perry's reference for friction factor once values of friction loss, pipe Diameter, pipe length, and slurry velocity are determined, and is dimensionless. For a pipe loop reactor the friction loss is typically the pressure differential of the reactor pump divided by the slurry density and multiplied by appropriate unit conversion factors. The friction factor of the inner surface of the loop reactor correlates with the root mean square surface roughness (rms) of the reactor. The root-mean-square (rms) surface roughness, which is a standard form of measurement in the steel and piping industries, describes the variation in surface elevation. It is also known as the standard deviation of the surface height. The smaller the rms, the smoother the surface. The rms measurement of a slurry loop reactor is a measurement of the roughness of the inner surface of the pipe segments that make up the reactor (i.e., the portion of the pipe segments that comes in contact with contents of the reactor).

Known slurry loop reactors have root mean square surface roughness values of 125 or greater (in units of micro inches). The root mean square surface roughness of the slurry loop reactor of the present invention is less than 125 micro inches, alternatively, less than 120 micro inches, alternatively, less than 115 micro inches, alternatively, less than 110 micro inches, alternatively, less than 105 micro inches, alternatively, less than 100 micro inches, alternatively, less than 95 micro inches, alternatively, less than 90 micro inches, alternatively, less than 80 micro inches, alternatively, less than 70 micro inches, alternatively, less than 60 micro inches, alternatively, less than 50 micro inches, alternatively, less than 40 micro inches, alternatively, less than 30 micro inches, alternatively, less than 20 micro inches. Any of the foregoing valves may be approximate.

It should be understood that the configuration of the loop reactor as illustrated in FIG. 1 is only one possible configuration, and could take other configurations and shapes providing the various interconnected sections define a closed loop. For example, the present invention also encompasses a horizontal loop reactor, in which the horizontal segments are longer in length than the vertical segments.

Returning to FIG. 1, the fluid slurry is circulated by means of an impeller (not shown) driven by a motor 24. Monomer, comonomer, if any, and make up diluent may be introduced via lines 26 and 28 respectively which can enter the reactor directly at one or a plurality of locations or can combine with condensed diluent recycle line 30 as shown. Catalyst is introduced via catalyst introduction means 32 which provides a zone (location) for catalyst introduction.

The withdrawn slurry take-off system includes a take-off assembly 34 which includes a take-off valve. The take-off assembly 34 is at the downstream end of a lower horizontal segment of the loop reactor. The location can be in an area near the last point in the loop where flow turns upward before the catalyst introduction point so as to allow fresh catalyst the maximum possible time in the reactor before it first passes a take-off point. However, the take-off assembly can be located on any segment or any elbow. The take-off assembly may include an emergency shut off valve.

Typically, the take-off assembly 34 includes a pipe usually the same diameter or nearly the same diameter as the flashline 36 downstream of the take-off valve. Alternatively, the take-off assembly may include other apparatus known in the art for removing fluid from a reactor. The pipe connects to an opening in the reactor and removes a portion of the fluid slurry. Also, the segment of the reactor to which the take-off assembly is attached can be of larger diameter to slow down the flow and hence further allow stratification of the flow so that the withdrawn slurry taken off can have an even greater concentration of solids. For this aspect of the invention, such stratification in the reactor does not comprise a “slurry concentrator”, which is defined herein as an apparatus additional to the reactor and take-off assembly whose primary function is to increase the solids concentration of the slurry being withdrawn. The opening may be located at or adjacent the downward curvature of a reactor elbow so as to take advantage of the centripetal force to increase solids concentration.

The take-off assembly 34 is downstream of the reactor 10 but upstream of the polymer recovery system or flashline 36. The take-off valve can be any type of control valve known in the art to be useful for controlling polymer slurry flow. Such valves include ball valves, v-ball valves, plug valves, globe valves and angle valves. The preferred valves have few or no places for solids to hang up on and have an opening greater than the larger polyethylene particle size even when the valve is required to be only a small amount open (i.e. 20-25% open). This gives a wide control range for the valve (20-100% open).

The present invention is not limited to any specific method or apparatus for removing product slurry from the loop reactor. For example, other aspects of the invention may use slurry concentrators or settling legs, or any other apparatus known in the art for removing slurry from a loop reactor. Also, settling legs or other removal apparatus may be used in conjunction with continuous take-off valves.

The withdrawn slurry is passed via conduit 36 to a polymer recovery system known in the art. In this aspect of the invention, withdrawn slurry is passed into high-pressure flash chamber 38. Prior to entering the chamber the withdrawn slurry may be heated by flashline heater 40. Vaporized diluent exits the flash chamber via line 42 for further processing which may include condensation by simple heat exchange using recycle condenser 50, and return to the system, without the necessity for compression, via recycle diluent line 30. Polymer particles are withdrawn from high-pressure flash chamber 38 via line 44 for further processing using techniques known in the art. They are passed to low-pressure flash chamber 46 and thereafter recovered as polymer product via line 48. Separated diluent passes through compressor 47 to line 42.

The present invention is not limited to any particular system for separating the polymer product from the liquid diluent. Any such system known in the art may be used. For example, in one aspect of the invention, a single flash chamber may be used to separate the polymer product from the diluent.

While this invention has been described in detail for the purpose of illustration, it is not to be construed as limited thereby, but is intended to cover all changes within the spirit and scope thereof.

1. A polymerization process comprising:
polymerizing in a loop reactor having an inner surface, at least one olefin monomer in a liquid medium to produce a fluid slurry comprising solid olefin polymer particles in a liquid medium, wherein said inner surface of said loop reactor has a root mean square surface roughness less than about 120 micro inches.

2. The process of claim 1 wherein said inner surface of said loop reactor has a root mean square surface roughness less than about 110 micro inches.

3. The process of claim 1 wherein said inner surface of said loop reactor has a root mean square surface roughness less than about 90 micro inches.

4. The process of claim 1 wherein said inner surface of said loop reactor has a root mean square surface roughness less than about 70 micro inches.

5. The process of claim 1 wherein said inner surface of said loop reactor has a root mean square surface roughness less than about 50 micro inches.

6. The process of claim 1 wherein said inner surface of said loop reactor has a root mean square surface roughness less than about 30 micro inches.

7. A polymerization process comprising:
a first polymerization step comprising polymerizing in a loop reactor at least one olefin monomer in a liquid medium to produce a first product fluid slurry comprising a liquid medium and solid olefin polymer particles having a melt index less than 0.3 gm/10 min and
a second polymerization step comprising polymerizing in said loop reactor at least one olefin monomer in a liquid medium to produce a second product fluid slurry comprising a liquid medium and solid olefin polymer particles having a melt index greater than 0.4 gm/10 min.

8. The process of claim 7 wherein the solid olefin polymer particles produced in said first polymerization step have a melt index less than 0.2 gm/10 min., and the solid olefin polymer particles produced in said second polymerization step have a melt index greater than 0.3 gm/10 min.

9. The process of claim 7 wherein the solid olefin polymer particles produced in said first polymerization step have a melt index less than 0.1 gm/10 min., and the solid olefin polymer particles produced in said second polymerization step have a melt index greater than 0.3 gm/10 min.

10. The process of claim 7 wherein the solid olefin polymer particles produced in said first polymerization step have a melt index less than 0.2 gm/10 min., and the solid olefin polymer particles produced in said second polymerization step have a melt index greater than 0.5 gm/10 min.

11. The process of claim 7 wherein the solid olefin polymer particles produced in said first polymerization step have a melt index less than 0.1 gm/10 min., and the solid olefin polymer particles produced in said second polymerization step have a melt index greater than 0.5 gm/10 min.

12. A slurry loop polymerization reactor having an inner surface comprising:
a plurality of major segments; and
a plurality of minor segments;
wherein each of said major segments is connected at one end thereof to one of said minor segments, and is connected at an opposite end thereof to another minor segment such that said major segments and said minor segments form a continuous flow path adapted to convey a fluid slurry, said reactor being substantially free from internal obstructions, and wherein said inner surface of said reactor has a root mean square surface roughness less than about 120 micro inches.

13. The loop polymerization reactor of claim 12 wherein said inner surface of said reactor has a root mean square surface roughness less than about 110 micro inches.

14. The loop polymerization reactor of claim 12 wherein said inner surface of said reactor has a root mean square surface roughness less than about 90 micro inches.

15. The loop polymerization reactor of claim 12 wherein said inner surface of said reactor has a root mean square surface roughness less than about 70 micro inches.

16. The loop polymerization reactor of claim 12 wherein said inner surface of said reactor has a root mean square surface roughness less than about 50 micro inches.

17. The polymerization process of claim 7 wherein said loop reactor has an inner surface, said inner surface having a root mean square surface roughness less than about 120 micro inches.

18. The polymerization process of claim 7 wherein said loop reactor has an inner surface, said inner surface having a root mean square surface roughness less than about 100 micro inches.

19. The polymerization process of claim 7 wherein said loop reactor has an inner surface, said inner surface having a root mean square surface roughness less than about 90 micro inches.

20. The polymerization process of claim 7 wherein said loop reactor has an inner surface, said inner surface having a root mean square surface roughness less than about 70 micro inches.

21. The polymerization process of claim 7 wherein said loop reactor has an inner surface, said inner surface having a root mean square surface roughness less than about 50 micro inches.

22. The polymerization process of claim 7 wherein said loop reactor has an inner surface, said inner surface having a root mean square surface roughness less than about 30 micro inches.
